(19) United States
(12) Patent Application Publication
(10) Pub. No.: US 2016/0313808 A1
(43) Pub. Date: Oct. 27, 2016

(54) Wearable Electronic Device

(71) Applicant: Acer Inc., New Taipei City (TW)

(72) Inventors: Tsung-Hsun Wu, New Taipei City (TW); Shao-Chi Chuang, New Taipei City (TW); Yu-Cheng Huang, New Taipei City (TW); Sheng-Wen Wu, New Taipei City (TW); Te-Jen Sung, New Taipei City (TW)

(21) Appl. No.: 14/809,319

(22) Filed: Jul. 27, 2015

(30) Foreign Application Priority Data
Apr. 24, 2015 (TW) 104113154

(51) Int. Cl. G06F 3/0362; H02K 7/06; G06F 1/16

(52) U.S. Cl. CPC G06F 3/0362; G06F 1/163; H02K 7/061

(57) ABSTRACT

A wearable electronic device has a device body, a motor, a crown, a voltage detecting module, a command determining module, and a processing module. The motor disposed in the device body has a motor body and a first transmission member. The crown has a button, a pivot and a transmission unit. The pivot is movably connected with the device body, and the two ends of the pivot are connected with the button and the transmission unit. When the transmission unit moves to the transmission position, the transmission unit connects with the first transmission member for linking the motor to the crown. An induced voltage is generated by the motor due to the rotation of the first transmission member and the transmission unit. The voltage detecting module detects the induced voltage. The command determining module determines a command corresponding to the induced voltage and the processing module implements the command.

### BACKGROUND OF THE INVENTION

1. Field of the Invention

The present invention relates to a wearable electronic device, and more particularly to a wearable electronic device whose crown is configured as a command input unit.

2. Description of the Related Art

With rapid developments in technologies related to wearable electronic devices, various types of wearable electronic devices, such as exercise bracelets or smartwatches, are available on the market. However, because of the compact size and portability of wearable electronic devices, the sizes of the command input units configured on those wearable electronic devices are usually limited, and physical buttons or touch panels are the most common options. As a result, the command input units of wearable electronic devices have limited sizes and functions, presenting hurdles for the developers of wearable electronic devices and causing inconvenience for users while manipulating wearable electronic devices; therefore, an improvement is needed.

### SUMMARY OF THE INVENTION

It is an object to provide a wearable electronic device whose crown is configured as a command input unit.

To achieve the abovementioned object, the wearable electronic device comprises a device body, a motor, a crown, a voltage detecting module, a command determining module, and a processing module. The motor is disposed in the device body. The motor comprises a motor body and a first transmission member. The crown comprises a button, a pivot and a transmission unit. The pivot is movably set in the device body. The button and the transmission unit are individually connected with the two ends of the pivot. When the transmission unit moves along with the pivot to a transmission position, the transmission unit connects with the first transmission member and then the motor is linked with the crown. Thus, when the button rotates, the transmission unit synchronously rotates with the first transmission member, and then an induced voltage is consequently generated by the motor. The voltage detecting module detects the induced voltage. The command determining module determines an operation command corresponding to the induced voltage, and then the processing module implements the operation command afterwards.

With the above-mentioned design, when users pull the crown, the transmission unit connected to the crown connects with the first transmission member and the motor consequently links with the crown. When the button is being rotated, the processing module implements a command corresponding to the induced voltage generated by the motor. Thus, users can manipulate the function of the wearable electronic device by rotating the crown, and the usability of the wearable electronic device is increased as well.

### BRIEF DESCRIPTION OF THE DRAWINGS

FIG. 1 is a partial exploded perspective view of the first embodiment of the wearable electronic device.

FIG. 2 is a hardware structure of the first embodiment of the wearable electronic device.

FIG. 3 is a schematic drawing of the first embodiment of the wearable electronic device.

FIG. 4 is a partial exploded perspective view of the second embodiment of the wearable electronic device.

FIG. 5 and FIG. 6 are schematic drawings of the second embodiment of the wearable electronic device.

### DETAILED DESCRIPTION OF THE PREFERRED EMBODIMENT

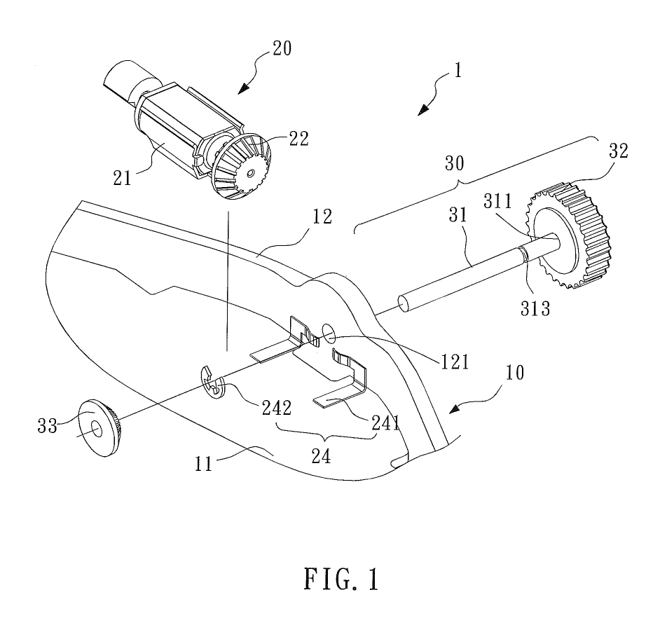

The technical content of the invention will become more apparent from the following detailed descriptions of several preferred embodiments. Please refer to FIG. 1 to FIG. 3, which present a partial exploded perspective view, the hardware structure, and the schematic drawing of the first embodiment of the wearable electronic device of the present invention.

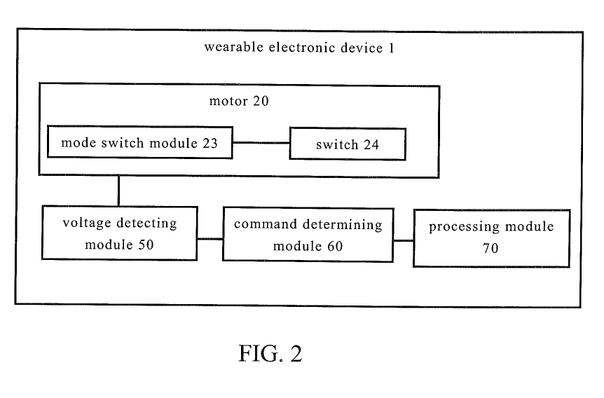

According to one embodiment of the present invention, the wearable electronic device 1 of the present invention is a watch or a pocket watch equipped with mechanical parts, such as a chronograph, a battery, a micro controller, and a circuit board, for facilitating operations of the watch or the pocket watch. It is noted that because those parts are well-known parts and not the improved aspect of the present invention, details related to those parts are omitted. As shown in FIG. 1 and FIG. 2, the wearable electronic device 1 of the present invention comprises a device body 10, a motor 20, a crown 30, a voltage detecting module 50, a command determining module 60, and a processing module 70. As shown in FIG. 1, the device body 10 comprises a bottom surface 11 and a side wall 12 with a through hole 121. The device body 10 of the present invention is a device body of a watch or a pocket watch for accommodating all the above-mentioned elements for facilitating operations of the wearable electronic device 1.

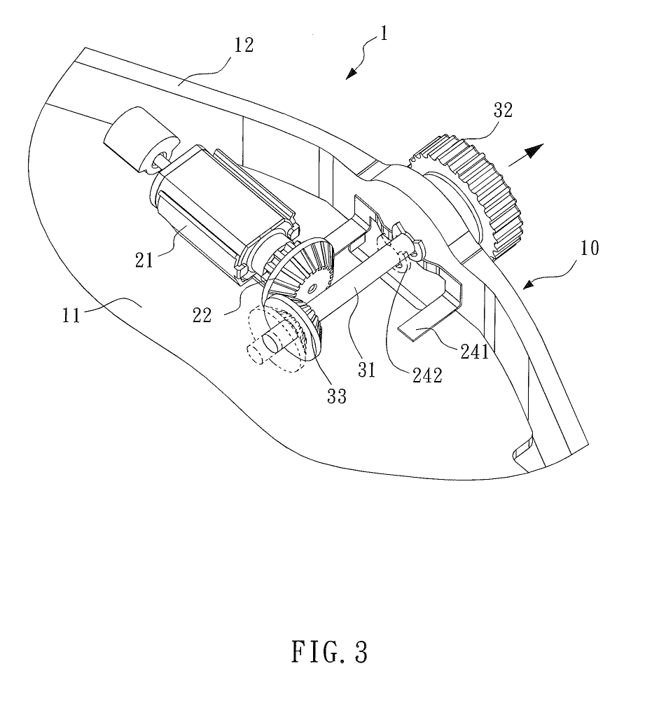

In the present embodiment, as shown in FIG. 1 and FIG. 3, the motor 20 comprises a motor body 21, a first transmission member 22, a mode switch module 23, and a switch 24. The first transmission member 22 is a sector gear and is disposed in the motor body 21 close to a side of the crown 30. The motor 20 has a motor mode and a generator mode. The mode switch module 23 is employed for switching the motor 20 to operate between the motor mode and the generator mode. The mode switch module 23 is electrically connected with the motor body 21 and the switch 24. As shown in FIG. 1, the switch 24 comprises an elastic piece 241 and a ring 242; the elastic piece 241 is disposed on the bottom surface 11 and is electrically connected with the motor body 21 via a built-in circuit board of the wearable electronic device 1. In the present embodiment, the ring 242 is an E-ring disposed in the connecting part 313 of the crown 30.

In the present embodiment, as shown in FIG. 3, when the ring 242 moves along with the crown 30 and then touches the elastic piece 241, the switch 24 is in a conducting state and the mode switch module 23 switches the motor 20 to operate in the generator mode. It is noted that, because the motor 20 has a built-in electric magnet and an induction coil, when the motor 20 operates in the generator mode, an induced voltage is generated due to changes in the magnetic field caused by the rotation of the induction coil in the motor 20. In contrast, when the ring 242 moves along with the crown 30 and then detaches from the elastic piece 241, the switch 24 is in a cut-off state and the mode switch module 23 switches the motor 20 to operate in the motor mode. It is noted that, because the motor 20 of the present invention is a vibration motor, the motor mode refers to a vibration mode. As shown in FIG. 1 and FIG. 3, the crown 30 comprises a button 31, a pivot 32, and a transmission unit 33. Two ends of the pivot 32 connect with the button 31 and the transmission unit 33 individually. The end of the pivot 32, without connecting with the button 31, passes through the through hole 121 and then enters the device body 10. The button 32 is exposed to the side wall 12. In the present embodiment, the transmission unit 33 is a sector gear and matches the first transmission member 22.

As shown in FIG. 3, when the button 31 is pulled away from the side wall 12 in a motion that is the same as the action of pulling the crown of a watch for adjusting the time, the pivot 32 moves relative to the device body 10 and the transmission unit 33 moves relative to the device body 10 until the transmission unit 33 engages with the first transmission member 22. When the transmission unit 33 engages with the first transmission member 22, the transmission unit 33 is in the transmission position. Moreover, as shown in FIG. 3, when the ring 242 moves along with the crown 30 and then touches the elastic piece 241, the switch 24 is in the conducting state and the motor 20 is switched to the generator mode. At this stage, users can rotate the button 32 clockwise or counter-clockwise to drive the pivot 32 to rotate and consequently to cause both the transmission unit 33 and the first transmission member 22 to rotate. As a result, the first transmission member 22 drives the built-in induction coil of the motor 20 to rotate, and then an induced voltage is generated due to the change in the magnetic field caused by the rotation of the induction coil.

As shown in FIG. 2, the voltage detecting module 50 is electrically connected with the motor 20. When the motor 20 operates in the generator mode, the voltage detecting module 50 detects the induced voltage generated by the motor 20 in the generator mode. The command determining module 60 is electrically connected with the voltage detecting module 50 and stores pre-determined operation commands. Each of the operation commands corresponds to a specific level of induced voltage. The command determining module 60 determines a specific operation command for the corresponding induced voltage. For example, according to one embodiment of the present invention, depending on the direction of rotation and on the number of turns performed by the button 32, the interval of the induced voltage ranges between ±1 mV˜=5 mV; technical personnel can pre-determine that when the induced voltage is +1 mV, the operation command corresponding to this induced voltage (+1 mV) is to increase the output volume; when the induced voltage is −1 mV, the operation command corresponding to this induced voltage (−1 mV) is to decrease the output volume. It is noted that the above-mentioned embodiment is for illustration only and that the present invention is not limited to this. The voltage detecting module 50 can be a detector with a voltage detecting function. The command determining module 60 can be a program, a hardware chip or a combination of the two above-mentioned embodiments; however, the present invention is not limited to those. The processing module 70 can be a control chip or a microprocessor. The suitable applications of the processing module 70 are not limited to those embodiments; the processing module 70 can be hardware, software, or firmware or any combination of two or more of the above-mentioned embodiments.

According to one embodiment of the present invention, if the voltage detecting module 50 detects that the induced voltage is +1 mV, and the operation command corresponding to +1 mV determined by the command determining module 60 is to increase the output volume, the processing module 70 will implement the operation command determined by the command determining module 60 accordingly, and the output volume will be increased, such that the crown 30 is configured as a command input unit for the wearable electronic device 1. After the manipulation is finished, users need only to push the crown 30 towards the side wall 12, which is the same action performed while pushing the crown in after adjusting the time on a standard wristwatch. As shown in FIG. 2, the pivot 32 moves relative to the device body 10 and causes the transmission unit 33 to move synchronously. As a result, the engagement between the transmission unit 33 and the first transmission member 22 is released accordingly, and the ring 242 also detaches from the elastic piece 241 due to the movement performed by the crown 30, and then the switch 24 is in the cut-off state and the motor 20 is switched to the motor mode; e.g., the motor 20 vibrates to signal users in the present embodiment.

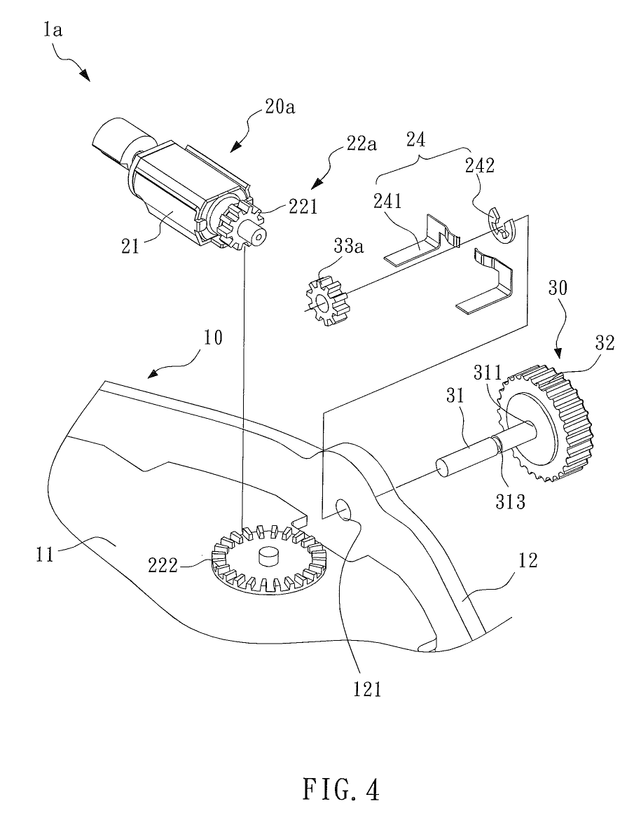

Please refer to FIG. 4 to FIG. 6, which present a partial exploded perspective view and schematic drawings of the second embodiment of the wearable electronic device.

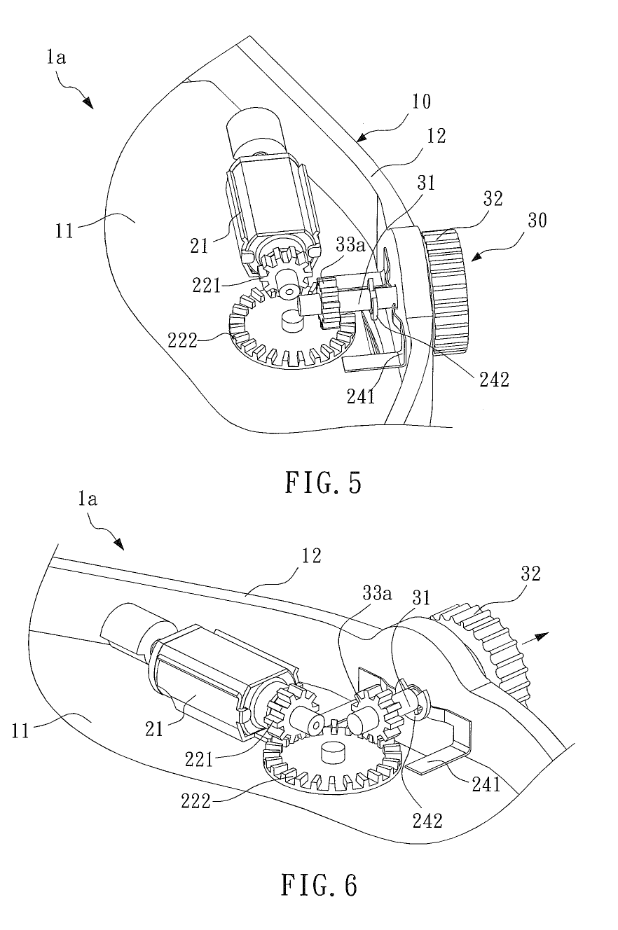

As shown in FIG. 4, in the second embodiment, the first transmission member 22a of the motor 20a of the wearable electronic device la comprises a first gear 221 and a transmission gear 222, wherein the transmission gear 222 is disposed on the bottom surface 11 and the first gear 221 engages with the transmission gear 222. The first gear 221 connects with the motor body 21. As shown in FIG. 5 and FIG. 6, when the transmission unit 33 moves along with the pivot 32 to the transmission position, the transmission unit 33 engages with the transmission gear 222, and then the motor 20 is linked with the crown 30. Therefore, the transmission unit 33 turns synchronously with the first gear 221 via the transmission gear 222; i.e., the transmission unit 33 does not engage with the first gear 221 directly, which is the major difference between the second embodiment and the first embodiment of the present invention. It is noted that other elements of the wearable electronic device 1 a are operated the same as those of the wearable electronic device 1; therefore, related details are omitted. For such details, please refer to the description presented in the wearable electronic device 1.

With this design, users can manipulate the wearable electronic device 1, la intuitively by pulling the crown, whose action is the same as the action performed while adjusting the time on a standard wristwatch, to increase the usability and convenience of the wearable electronic device 1, la.

As described above, the objectives, means, and effectiveness in the present invention are different from the characteristics in the prior art. It should be noted that the embodiments described above are for illustrating the principles and effects of the present invention, and not for limiting the scope of the present invention. Any person skilled in the art shall be able to make modifications and changes to the embodiments without departing from the technical principle and spirit of the present invention. The claims of the present invention within the scope of protection are described below.

What is claimed is:

1. A wearable electronic device comprising:
a device body;
a motor disposed in the device body, the motor comprising a motor body and a first transmission member;
a crown comprising a button, a pivot, and a transmission unit;
the pivot is movably set in the device body, and two ends of the pivot are connected to the button and the transmission unit to allow the transmission unit to move relative to the device body, wherein when the transmission unit moves along with the pivot to a transmission position, the transmission unit connects with the first transmission member to link the motor with the crown and the first transmission member rotates synchronously with the transmission unit, and then an induced voltage is generated by the motor when the button rotates;
a voltage detecting module electrically connected with the motor for detecting the induced voltage;
a command determining module for determining an operation command corresponding to the induced voltage; and
a processing module for implementing the operation command.

2. The wearable electronic device as claimed in claim 1, wherein the first transmission member is a sector gear, and the transmission unit is a sector gear, wherein when the transmission unit moves to the transmission position, the first transmission member engages with the transmission unit and then the motor is linked with the crown.

3. The wearable electronic device as claimed in claim 1, the first transmission member comprising a first gear and a transmission gear, wherein when the first gear engages with the transmission gear, the transmission unit moves along with the pivot to the transmission position and the transmission unit engages with the transmission gear for linking the motor to the crown.

4. The wearable electronic device as claimed in claim 1, the motor having a motor mode and a generator mode, the motor comprising a mode switch module electrically connected with the motor body for switching the motor to operate between the motor mode and the generator mode.

5. The wearable electronic device as claimed in claim 4, the motor comprising a switch, the mode switch module being electrically connected with the motor and the switch, such that when the transmission unit moves along with the crown to the transmission position, the switch is in a conducting state and the mode switch module switches the motor to operate in the generator mode.

6. The wearable electronic device as claimed in claim 5, the switch comprising an elastic piece and a ring, wherein when the switch is in the conducting state, the elastic piece touches the ring.

7. The wearable electronic device as claimed in claim 4, wherein when the transmission unit leaves the transmission position when the crown is moved, the switch is in a cut-off state and the mode switch module switches the motor to operate in the motor mode.

8. The wearable electronic device as claimed in claim 7, the switch comprising an elastic piece and a ring, wherein when the switch is in the cut-off state, the ring detaches from the elastic piece.
